(19) United States
(12) Patent Application Publication
(10) Pub. No.: US 2020/0329683 A1
(43) Pub. Date: Oct. 22, 2020

(54) Lamp and Fish Tank Combination Assembly

(71) Applicant: Antonio Manuel Rodriguez Perez, Bradenton, FL (US)

(72) Inventor: Antonio Manuel Rodriguez Perez, Bradenton, FL (US)

(21) Appl. No.: 16/918,498

(22) Filed: Jul. 1, 2020

Related U.S. Application Data
(63) Continuation-in-part of application No. 15/850,979, filed on Dec. 21, 2017.

(51) Int. Cl. A01K 63/06; F21V 23/04; F21S 9/02

(52) U.S. Cl. CPC A01K 63/06; F21Y 2115/10; F21S 9/02; F21V 23/04

(57) ABSTRACT

A lamp and fish tank combination assembly for emitting light downwardly towards the aquarium and outwardly from a light source includes a tank that is filled with water and houses fish. A lighting unit is positioned on top of the tank. The lighting unit emits light downwardly into the tank and laterally from the lighting unit when the lighting unit is turned on.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to illuminated aquarium devices and more particularly pertains to a new illuminated aquarium device for emitting light downwardly towards the aquarium and outwardly from a light source.

### BRIEF SUMMARY OF THE INVENTION

An embodiment of the disclosure meets the needs presented above by generally comprising a tank that is configured to be filled with water and house fish. A lighting unit is positioned on top of the tank. The lighting unit emits light downwardly into the tank and laterally from the lighting unit when the lighting unit is turned on.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front view of a lamp and fish tank combination assembly according to an embodiment of the disclosure.

FIG. 2 is an exploded view of components of an embodiment of the disclosure.

FIG. 3 is a bottom view of an embodiment of the disclosure.

FIG. 4 is a front view of an embodiment of the disclosure.

FIG. 5 is a cross-sectional view of an embodiment of the disclosure taken along line 5-5 of FIG. 4.

### DETAILED DESCRIPTION OF THE INVENTION

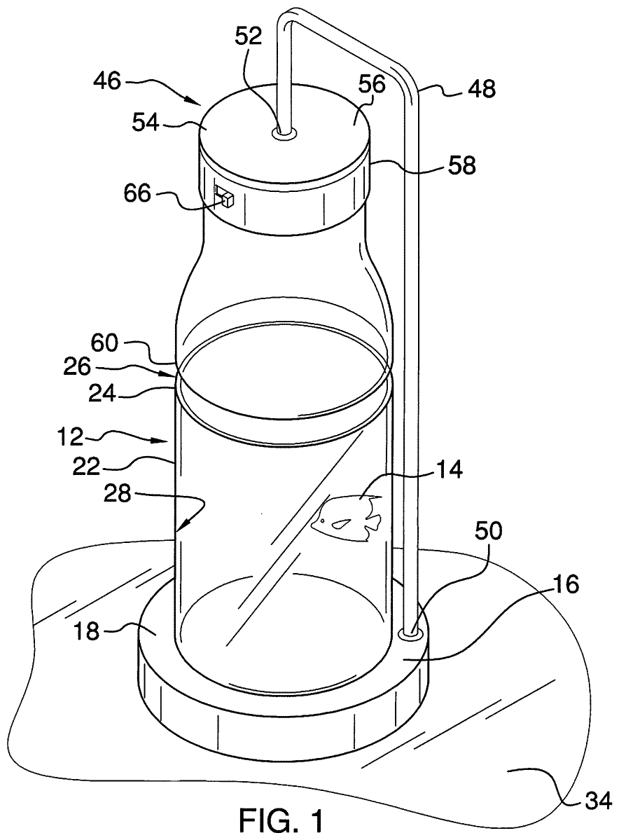

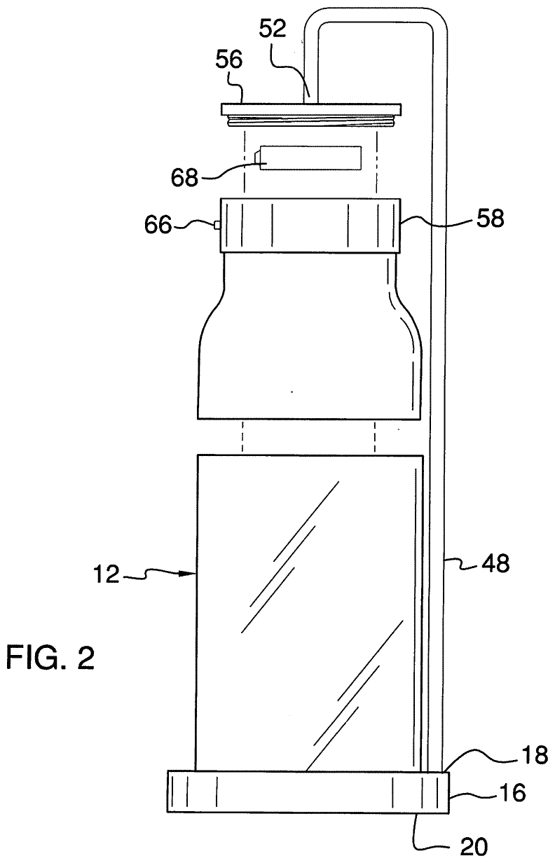

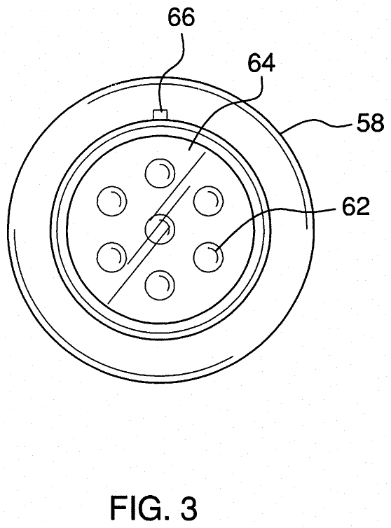

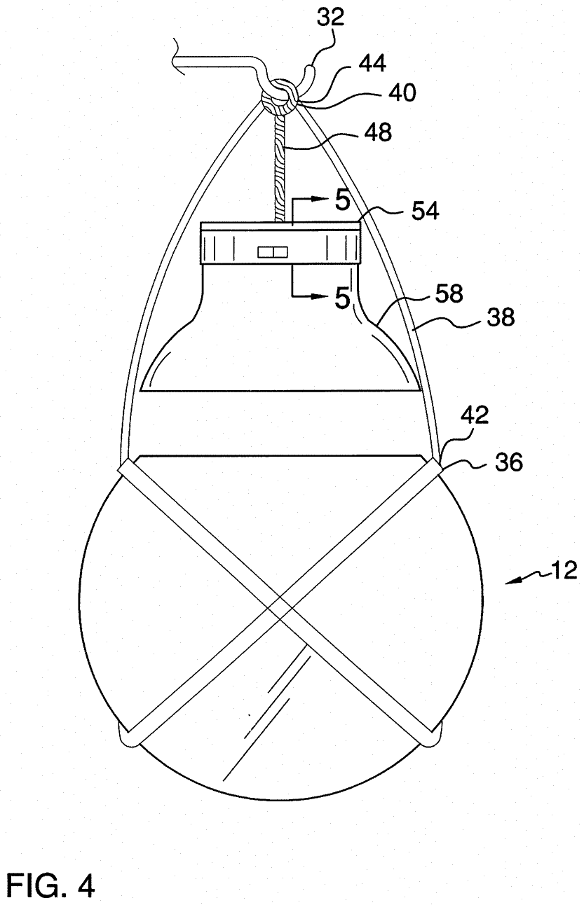

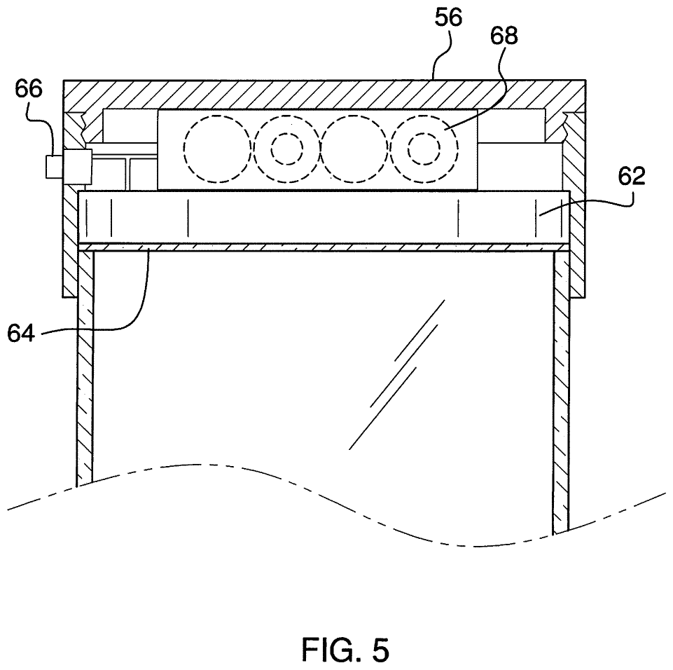

With reference now to the drawings, and in particular to FIGS. 1 through 5 thereof, a new illuminated aquarium device embodying the principles and concepts of an embodiment of the disclosure and generally designated by the reference numeral 10 will be described.

As best illustrated in FIGS. 1 through 5, the lamp and fish tank combination assembly 10 generally comprises a tank 12 that is filled with water and houses fish 14. The tank 12 includes a base 16 that has a top side 18 and a bottom side 20. A perimeter wall 22 is attached to and extends upwardly from the base 16. The perimeter wall 22 comprises a transparent material and has an upper edge 24 that forms an opening 26 that extends into an interior 28 bounded by the perimeter wall 22. The perimeter wall 22 may have a cylindrical shape but may have another shape.

A retaining member 30 may be included. The retaining member 30 hangs from a catch 32 and securely retains the tank 12 over a ground surface 34. The retaining member 30 includes a plurality of holding straps 36. Each of the holding straps 36 is continuous and wraps around the perimeter wall 22 of the tank 12 such that each of the holding straps 36 frictionally engages the tank 12. A plurality of hanging straps 38 are including where each of the hanging straps 38 has a top end 40 and a bottom end 42. Each of the bottom ends 42 is attached to a selected one of the holding straps 36 and extends outwardly and upwardly from a corresponding one of the holding straps 36. An attachment member 44 is included wherein each of the top ends 40 is coupled to the attachment member 44. The attachment member 44 is positioned on the catch 32 wherein the tank is held over a ground surface 34. The attachment member 44 may form a closed loop shape, but may be any shape suitable to retain each of the hanging straps 38, each of the holding straps 36 and the tank 12 above a ground surface 28. The catch 32 may be a hook, a nail or any other loadbearing material that protrudes from a raised surface.

A lighting unit 46 is positioned on top of the tank 12. The lighting unit 46 emits light downwardly into the tank 12 and laterally from the lighting unit 46 when the lighting unit 46 is turned on. The lighting unit 46 comprises a support 48 has a first end 50, a second end 52 and is elongated from the first end 50 to the second end 52. The first end 50 is coupled to a securing member. The securing member is selected from one of the group including the base 12 or the attachment member 44.

A housing 54 is included and has an upper wall 56 and a peripheral wall 58 that is attached to and extends downwardly from the upper wall 56. The peripheral wall 58 is translucent. The upper wall 56 is removable from the peripheral wall 58. The second end 52 of the support 48 is attached to the housing 54 such that the housing 54 is positioned over the tank 12 wherein a lower edge 60 of the housing 54 is spaced from the upper edge 24 of the perimeter wall 22.

A plurality of light emitters 62 is mounted in the housing 48. Each of the light emitters 62 emits light downwardly into the tank 12 and outwardly through the peripheral wall 52 when the light emitters 62 are turned on. Each of the light emitters 62 comprises a light emitting diode. A window 64 is attached to the peripheral wall 52 and covers the light emitters 62 such that the light emitters 62 are positioned between the window 64 and the upper wall 50. The window 64 may comprise of a lens such that the window 64 may reflect light outwardly from the housing 48 at different angles as well as alter a color of the light emitted.

A power switch 66 is electrically coupled to each of the light emitters 62 and is actuated to turn the light emitters 62 on. The power switch 66 is mounted on the peripheral wall 52. A power supply 68 is electrically coupled to the light emitters 62. The power supply 68 is positioned within the housing 48 and is accessible when the upper wall 50 is removed from the peripheral wall 52. The power supply 68 comprises at least one battery.

In use, the assembly 10 is used conventionally as a light source. The tank 12 is either positioned upright with the base 16 on a ground surface 34 or placed on a catch 32 wherein the retaining member 30 holds the tank 12 over a ground surface 34. The power switch 66 is actuated to illuminate each of the light emitters 62. Each of the light emitters 62 emits light downwardly toward the tank 12 and outwardly from the peripheral wall 52 such that the light emitters 62 act as a conventional light source.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lamp and aquarium combination assembly comprising:
a tank configured to be filled with water and house fish; and
a lighting unit being positioned over said tank, said lighting unit emitting light downwardly into said tank and laterally from said lighting unit when said lighting unit is turned on.

2. The lamp and aquarium combination assembly according to claim 1, wherein said tank includes:
a base having a top side and a bottom side; and
a perimeter wall being attached to and extending upwardly from said base, said perimeter wall being comprised of a transparent material and having an upper edge forming an opening extending into an interior bounded by said perimeter wall.

3. The lamp and aquarium combination assembly according to claim 2, wherein said perimeter wall has a cylindrical shape.

4. The lamp and aquarium combination assembly according to claim 2, further including a retaining member being positioned on said tank and configured to hang from a catch such that said tank is securely retained over a ground surface.

5. The lamp and aquarium combination assembly according to claim 4, wherein said hold includes:
a plurality of holding straps, each of said holding straps being continuous and wrapping around said perimeter wall such that each of said holding straps frictionally engage said tank;
a plurality of hanging straps having a top end and a bottom end, each of said bottom ends being attached to a selected one of said holding straps, each of said hanging straps extending outwardly and upwardly from a corresponding one of said holding straps; and
an attachment member, each of said top ends being coupled to said attachment member, said attachment member being configured to be positioned on a catch wherein said tank is held over a ground surface, said attachment member forming a closed loop shape.

6. The lamp and aquarium combination assembly according to claim 5, wherein said lighting unit comprises:
a support having a first end and a second end, said support being elongated from said first end to said second end, said first end being coupled to a securing member, said securing member being selected from one of the group including said base or said attachment member;
a housing including an upper wall and a peripheral wall being attached to and extending downwardly from said upper wall, said peripheral wall being translucent, said upper wall being removable from said peripheral wall, said second end being attached to said housing such that said housing is positioned over said tank wherein a lower edge of said housing is spaced from said upper edge of said perimeter wall;
a plurality of light emitters being mounted in said housing, each of said light emitters emitting light downwardly into said tank and outwardly through said peripheral wall when said light emitters are turned on, each of said light emitters comprising a light emitting diode;
a window being attached to said peripheral wall and covering said light emitters such that said light emitters are positioned between said window and said upper wall;
a power switch being electrically coupled to each of said light emitters and being actuated to turn each of said light emitters on, said power switch being mounted on said peripheral wall; and
a power supply being electrically coupled to said light emitters, said power supply being positioned within said housing, said power supply comprising at least one battery, said power supply being accessible when said upper wall is removed from said peripheral wall.

7. The lamp and aquarium combination assembly according to claim 2, wherein said lighting unit comprises:
a support having a first end and a second end, said support being elongated from said first end to said second end, said first end being coupled to said base
a housing including an upper wall and a peripheral wall being attached to and extending downwardly from said upper wall, said peripheral wall being translucent, said upper wall being removable from said peripheral wall, said second end being attached to said housing such that said housing is positioned over said tank wherein a lower edge of said housing is spaced from said upper edge of said perimeter wall;
a plurality of light emitters being mounted in said housing, each of said light emitters emitting light downwardly into said tank and outwardly through said peripheral wall when said light emitters are turned on, each of said light emitters comprising a light emitting diode;
a window being attached to said peripheral wall and covering said light emitters such that said light emitters are positioned between said window and said upper wall;
a power switch being electrically coupled to each of said light emitters and being actuated to turn each of said light emitters on, said power switch being mounted on said peripheral wall; and
a power supply being electrically coupled to said light emitters, said power supply being positioned within said housing, said power supply comprising at least one battery, said power supply being accessible when said upper wall is removed from said peripheral wall.

8. A lamp and aquarium combination assembly comprising:
a tank configured to be filled with water and house fish, said tank including:
a base having a top side and a bottom side;
a perimeter wall being attached to and extending upwardly from said base, said perimeter wall being comprised of a transparent material and having an upper edge forming an opening extending into an interior bounded by said perimeter wall, said perimeter wall having a cylindrical shape;
a retaining member being positioned on said tank and configured to hang from a catch such that said tank is securely retained over a ground surface, said retaining member including:
a plurality of holding straps, each of said holding straps being continuous and wrapping around said perimeter wall such that each of said holding straps frictionally engage said tank;
a plurality of hanging straps having a top end and a bottom end, each of said bottom ends being attached to a selected one of said holding straps, each of said hanging straps extending outwardly and upwardly from a corresponding one of said holding straps;
an attachment member, each of said top ends being coupled to said attachment member, said attachment member being configured to be positioned on a catch wherein said tank is held over a ground surface, said attachment member forming a closed loop shape;
a lighting unit being positioned over said tank, said lighting unit emitting light downwardly into said tank and laterally from said lighting unit when said lighting unit is turned on, said lighting unit comprising:
a support having a first end and a second end, said support being elongated from said first end to said second end, said first end being coupled to a securing member, said securing member being selected from one of the group including said base or said attachment member;
a housing including an upper wall and a peripheral wall being attached to and extending downwardly from said upper wall, said peripheral wall being translucent, said upper wall being removable from said peripheral wall, said second end being attached to said housing such that said housing is positioned over said tank wherein a lower edge of said housing is spaced from said upper edge of said perimeter wall;
a plurality of light emitters being mounted in said housing, each of said light emitters emitting light downwardly into said tank and outwardly through said peripheral wall when said light emitters are turned on, each of said light emitters comprising a light emitting diode;
a window being attached to said peripheral wall and covering said light emitters such that said light emitters are positioned between said window and said upper wall;
a power switch being electrically coupled to each of said light emitters and being actuated to turn each of said light emitters on, said power switch being mounted on said peripheral wall; and
a power supply being electrically coupled to said light emitters, said power supply being positioned within said housing, said power supply comprising at least one battery, said power supply being accessible when said upper wall is removed from said peripheral wall.
